(19) United States
(12) Patent Application Publication
(10) Pub. No.: US 2025/0111956 A1
(43) Pub. Date: Apr. 3, 2025

(54) STEAM-WATER SEPARATOR AND BOILING-WATER REACTOR

(71) Applicant: Hitachi-GE Nuclear Energy, Ltd., Ibaraki (JP)

(72) Inventors: Kiyoshi FUJIMOTO, Tokyo (JP); Kenichi KATONO, Tokyo (JP)

(21) Appl. No.: 18/790,483

(22) Filed: Jul. 31, 2024

(30) Foreign Application Priority Data
Sep. 29, 2023 (JP) 2023-169837

(51) Int. Cl. G21C 13/02; G21C 1/08

(52) U.S. Cl. CPC G21C 13/022; G21C 1/084

(57) ABSTRACT

Provided is a reactor that allows a fluid to easily flow. A reactor includes a reactor pressure vessel, a core provided in the reactor pressure vessel and loaded with a fuel assembly, and a steam-water separator provided in the reactor pressure vessel separates water and steam from a fluid containing the steam and the water generated in the core. The steam-water separator includes an annular flow channel through which the fluid flows from an upper side to a lower side and which opens to the lower side of the steam-water separator, and an opening that discharges air bubbles in the fluid flowing through the annular flow channel a side of the steam-water separator.

### CROSS-REFERENCE TO RELATED APPLICATION

The present application claims priority from Japanese application JP2023-169837, filed on Sep. 29, 2023, the content of which is hereby incorporated by reference into this application.

### TECHNICAL FIELD

In a forced-circulation type boiling-water reactor (forced circulation reactor), a plurality of steam-water separators are installed in an upper part of a core in order to separate a fluid containing steam and water generated in the core into steam and water. In the steam-water separator, swirl velocity is given to the fluid by a swirler (swirl vane) in a diffuser, and steam and water are separated by a centrifugal force using a gas-liquid density difference. The separated water descends from a space in an inner cylinder of the steam-water separator through an annular flow channel between the inner cylinder and an outer cylinder, is discharged from a discharge outlet below the outer cylinder of the steam-water separator, returns to a downcomer, and is sent to the core again by a recirculation pump. On the other hand, the separated steam is discharged from a flow channel at the center of the steam-water separator to outside of the steam-water separator, flows into a steam dryer so that moisture is removed, and then is sent to a turbine. As a result, moisture can be removed as much as possible from the steam including moisture generated in the core, and efficient power generation is realized.

In addition, in a three-stage steam-water separator used in an advanced boiling-water reactor (forced circulation reactor, ABWR), separated water containing little steam is discharged from a downward discharge outlet in an annular flow channel between a first-stage inner cylinder and a first-stage outer cylinder. Further, the separated water and steam are discharged from discharge outlets respectively provided below outer cylinders of a second stage and a third stage from the bottom of the steam-water separator.

On the other hand, in a natural circulation type boiling-water reactor (natural circulation reactor) that does not use a recirculation pump, a large-diameter circular pipe flow channel called a chimney is installed in the upper part of the core. Then, a circulation force due to a density difference between fluids inside and outside a shroud is increased, and cooling water flows into the core. In the natural circulation reactor, an average quality at an inlet of the steam-water separator is large as compared to the ABWR. Further, due to an influence of a complicated flow in the chimney, variation in quality of a gas-liquid two-phase flow at a single inlet of the steam-water separator is larger than the ABWR. When quality at the inlet of the steam-water separator, that is, an amount of steam increases, the steam flows into the annular flow channel of the first stage, and the steam is discharged from the discharge outlet. Therefore, carry under (a ratio of a mass flow rate of steam in a fluid discharged from the discharge flow channel of the steam-water separator) increases. As a large amount of steam is contained in downcomer outside the shroud due to an increase of the carry under, a fluid density decreases. As a result, there is a possibility that the natural circulation flow rate decreases, and that a cooling performance of the core decreases.

PTL 1 describes that “a steam-water separator 6 includes a standpipe 7, a diffuser 8, a swirler 9, and three-stage steam-water separation units 10a to 10c. The diffuser 8 is installed at an upper end of the standpipe 7, and the swirler 9 is installed in the diffuser 8. An inner cylinder 11a is attached to an upper end of the diffuser 8, and a pick-off ring 13a is attached to an upper end of the inner cylinder 11a. An outer cylinder 12a providing a drain channel 15a between the outer cylinder 12a and the inner cylinder 11a is installed on the pick-off ring 13a. An air bubble collection chamber 22 provided at a lower end portion of the drain channel 15a is provided between a partitioning member 21 and the outer cylinder 12a. An annular plate 20 positioned below the outer cylinder 12a is attached to an outer surface of a pipeline 22. A discharge outlet 18a is provided between the annular plate 20 and a lower end of the outer cylinder 12a. Air bubbles separated from water flowing through a bent portion 25 are collected in the air bubble collection chamber 22”.

### CITATION LIST

### Patent Literature

PTL 1: JP 2009-257770 A

### SUMMARY OF INVENTION

### Technical Problem

In the steam-water separator 6 described in PTL 1, the fluid containing steam and water flowing downward in the drain channel 15a collides with the annular plate 20 at the lower ends of the inner cylinder 11a and the outer cylinder 12a. Further, a flowing direction of the fluid changes to a side in the annular plate 20, and is discharged to a side of the outer cylinder 12a (the steam-water separator 6) through the discharge outlet 18a. Therefore, a pressure loss is significantly large, and the fluid hardly flows.

An object of the present disclosure is to provide a steam-water separator and a boiling-water reactor that allow a fluid to easily flow.

### Solution to Problem

A steam-water separator according to the present disclosure includes: a standpipe configured to guide a fluid containing steam and water generated in a core from a lower side to an upper side; a diffuser connected to an upper side end of the standpipe and constitutes a flow channel, the diffuser having a flow channel cross-sectional area of the flow channel enlarged to be larger upward from the upper side end; an inner cylinder in a cylindrical shape communicating with an upper side end of the diffuser to constitute a flow channel; an outer cylinder in a cylindrical shape that constitutes an annular flow channel between the outer cylinder and the inner cylinder, and includes a discharge outlet at a lower end of the annular flow channel, the discharge outlet opening downward; a protruding portion provided so as to protrude to the annular flow channel, the protruding portion protruding from at least one of surfaces of the outer cylinder and the inner cylinder; an opening defined in the outer cylinder at least in a portion immediately below the protruding portion, the opening communicating the annular flow channel with outside of the outer cylinder and opening toward a side of the outer cylinder; an annular plate closing an upper side of the outer cylinder and constituting a circular hole whose diameter is smaller than a diameter of the inner cylinder; a pick-off ring extending downward in a cylindrical shape from an inner peripheral edge defining the circular hole of the annular plate, the pick-off ring making the circular hole constitute a flow channel to an upper part of the inner cylinder; and a swirler provided as an axial center of a flow channel through which the fluid flows in the standpipe. Other solutions will be described later in embodiments for carrying out the invention.

### Advantageous Effects of Invention

According to the present disclosure, it is possible to provide a steam-water separator and a boiling-water reactor that allow a fluid to easily flow.

### BRIEF DESCRIPTION OF DRAWINGS

FIG. 1 is a longitudinal sectional view of a schematic structure of a boiling-water reactor (natural circulation reactor) of the present disclosure.

FIG. 2 is an external view of a steam-water separator of the present disclosure.

FIG. 3 is a longitudinal sectional view of the steam-water separator illustrated in FIG. 2.

FIG. 4 is a sectional view taken along line B-B in FIGS. 2 and 3.

FIG. 5 is a sectional view taken along line C-C in FIGS. 2 and 3.

FIG. 6 is a bird's-eye view near an opening of the steam-water separator illustrated in FIG. 2 as viewed from outside of the steam-water separator.

FIG. 7 is a view for illustrating a behavior of a fluid flowing through a first-stage annular flow channel, and is a view illustrating a state in which a focus is given on specific air bubbles in the first-stage annular flow channel.

FIG. 8 is a view for illustrating a behavior of the fluid flowing through the first-stage annular flow channel, and is a view illustrating a state in which the air bubbles illustrated in FIG. 7 flow near a flow-rate reducing component.

FIG. 9 is a view for illustrating a behavior of the fluid flowing through the first-stage annular flow channel, and is a view illustrating a state when the air bubbles illustrated in FIG. 7 reach obliquely below the flow-rate reducing component.

FIG. 10 is a view for illustrating a behavior of the fluid flowing through the first-stage annular flow channel, and is a view illustrating a state in which the air bubbles existing in a stagnation region are discharged outside the first-stage outer cylinder through the opening.

FIG. 11 is a chart showing a relationship between quality at an inlet of the steam-water separator and a carry under.

FIG. 12 is a partial sectional view of the steam-water separator of another embodiment.

FIG. 13 is an external view of the steam-water separator according to still another embodiment.

FIG. 14 is a longitudinal sectional view of the steam-water separator illustrated in FIG. 13.

FIG. 15 is a sectional view taken along line D-D in FIGS. 13 and 14.

FIG. 16 is a sectional view taken along line E-E in FIGS. 13 and 14.

FIG. 17 is a bird's-eye view near the opening of the steam-water separator illustrated in FIG. 13 as viewed from outside of the steam-water separator.

FIG. 18 is a longitudinal sectional view of a schematic structure of a boiling-water reactor (forced circulation reactor) of the present disclosure.

FIG. 19 is a longitudinal sectional view illustrating a steam-water separator of a reference example.

FIG. 20 is a horizontal sectional view illustrating a plurality of steam-water separators of the reference example.

### DESCRIPTION OF EMBODIMENTS

Hereinafter, modes for carrying out the present disclosure (referred to as embodiments) will be described with reference to the drawings. In the following description of one embodiment, another embodiment applicable to the one embodiment will also be described as appropriate. The present disclosure is not limited to the one embodiment described below, and different embodiments may be combined or may be modified in any manner as long as the effects of the present disclosure are not significantly impaired. Further, the same members are denoted by the same reference numerals, and redundant description will be omitted. Moreover, elements having the same function are denoted by the same name. Illustrated contents are merely schematic, and for convenience of illustration, within a range not significantly impairing the effects of the present disclosure, an actual configuration may be changed, or illustration of some members may be omitted or modified through the drawings. In addition, all the configurations are not necessarily provided in the same embodiment.

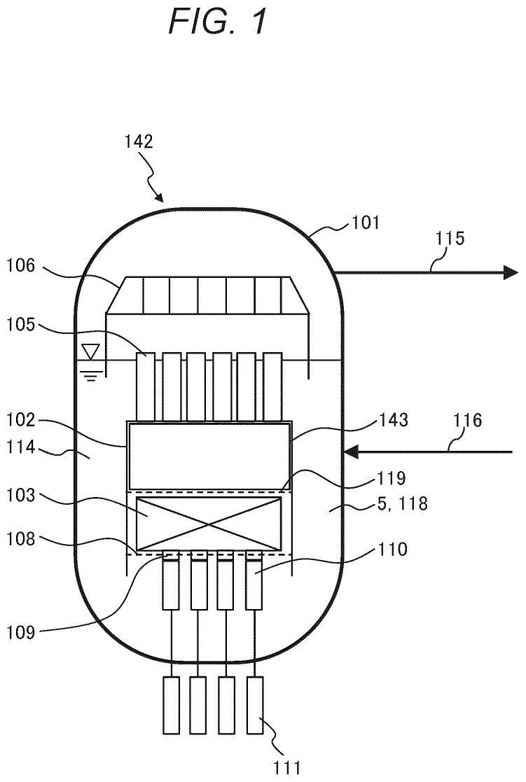

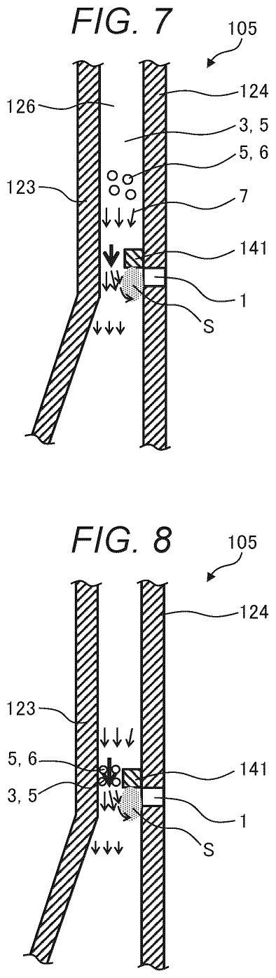

FIG. 1 is a longitudinal sectional view of a schematic structure of a boiling-water reactor (natural circulation reactor) of the present disclosure. Hereinafter, the boiling-water reactor (natural circulation reactor) of the present disclosure is referred to as a reactor 142. The reactor 142 is of a natural circulation type. Therefore, the reactor 142 does not include a recirculation pump 113 (described later), and includes a chimney 143. In a natural circulation reactor, a fluid 5 naturally circulates inside and outside a core 103 using a density difference of the fluid 5 inside and outside the core 103 as a driving force. Although described later with reference to FIG. 7 and the like, for example, the fluid 5 mainly contains liquid water 3 (coolant 118), or liquid water 3 and air bubbles 6 (steam in water). As the natural circulation type, it is possible to suppress occurrence of cavitation in, for example, an impeller 177 (described later).

The reactor 142 includes a reactor pressure vessel 101, the core 103, and a steam-water separator 105. The core 103 is provided in the reactor pressure vessel 101 and is loaded with a fuel assembly. The steam-water separator 105 is provided in the reactor pressure vessel 101, and separates the liquid water 3 and the air bubbles 6 from the fluid 5 containing the air bubbles 6 (steam) and the liquid water 3 generated in the core 103.

A cylindrical core shroud 102 is provided in the reactor pressure vessel 101, and the core 103 loaded with a plurality of fuel assemblies (not illustrated) is disposed in the core shroud 102. An upper grid plate 119 is installed at an upper end of the core 103 in the core shroud 102, the chimney 143 is installed above the upper lattice plate, and a core support plate 108 is installed at a lower end of the core in the core shroud 102. Further, a plurality of fuel support fittings 109 are installed on the core support plate 108.

In addition, in the reactor pressure vessel 101, a control rod guide tube 110 capable of inserting a plurality of cross-shaped control rods (not illustrated) into the core 103 for controlling nuclear reaction of the fuel assembly is provided. A control rod drive mechanism 111 is provided in a housing installed below a bottom of the reactor pressure vessel 101, and the cross-shaped control rods are connected to the control rod drive mechanism 111. The coolant 118 flowing into the core 103 is heated by the nuclear reaction of the fuel assembly and become the fluid 5 (mixed flow of the water 3 and the air bubbles 6) containing steam and water, and the fluid 5 flows into the steam-water separator 105 disposed at an upper part of the core 103.

A swirling speed of the fluid 5 flowing into the steam-water separator 105 is given by a swirler 122 (described later) in the steam-water separator 105, a centrifugal force acts on the fluid 5 by the swirling speed, the water 3 and the air bubbles 6 are separated by a density difference between the liquid water 3 and the air bubbles 6, and the water 3 again flows to a downcomer 114 as the coolant 118. On the other hand, the air bubbles 6 flow into a steam dryer 106 as steam, and moisture is further removed. In this way, the steam with a moisture content of 0.1 mass percent or less is sent to a turbine (not illustrated) through a main steam pipe 115, and thus power generation is performed. The coolant 118 flowing into the reactor pressure vessel 101 from a feed-water pipe 116 via a condenser or the like (not illustrated) flows downward in the downcomer 114, and flows into the core 103 by a circulating force due to a density difference between the fluids 5 inside and outside the core shroud 102. For example, the fluid outside the core 103 mainly contains the liquid water 3, and has a relatively large density, and the fluid inside the core 103 mainly contains the steam (air bubbles 6), and has a relatively small density.

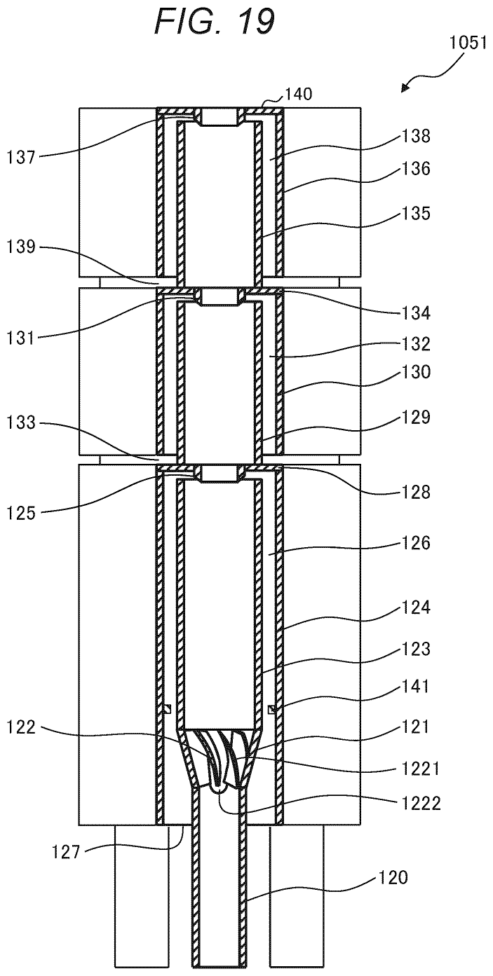

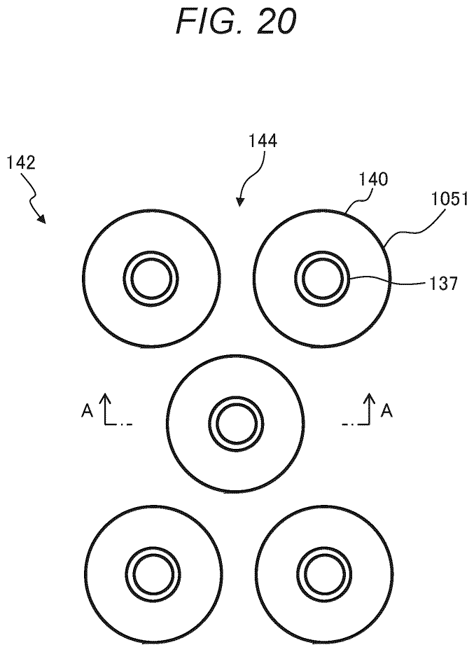

For convenience, first, a steam-water separator 1051 of a reference example will be described with reference to FIGS. 19 and 20. The steam-water separator 1051 of the reference example has the same structure as that of the steam-water separator 105 (described later) of the present disclosure except that an opening 1 (described later) is not provided. In the present disclosure, the steam-water separators 105 and 1051 having two or more stages of separation mechanisms are preferable, and in FIGS. 19 and 20, the steam-water separators 105 and 1051 having three stages of separation mechanisms are shown as an example. However, the steam-water separators 105 and 1051 may have one or two stages, or four or more stages.

FIG. 19 is a longitudinal sectional view illustrating the steam-water separator 1051 of the reference example. FIG. 19 is a sectional view taken along line A-A in FIG. 20 described later. The steam-water separator 1051 includes a standpipe 120 that guides the fluid 5 (fluid containing steam and water) generated in the core 103 (FIG. 1) from a lower side to an upper side. The steam-water separator 1051 includes a diffuser 121 that is connected to an upper end surface of the standpipe 120 and that constitutes a flow channel whose flow channel cross-sectional area is enlarged to be larger upward from the upper end surface. The steam-water separator 1051 includes a first-stage inner cylinder 123 communicating with the upper side end of the diffuser 121 to constitute a flow channel. The first-stage inner cylinder 123 (inner cylinder), and a second-stage inner cylinder 129 and a third-stage inner cylinder 135 that are described later are in a cylindrical shape.

The steam-water separator 1051 includes a first-stage annular flow channel 126 that concentrically surrounds the first-stage inner cylinder 123 at an interval. The steam-water separator 1051 includes a first-stage outer cylinder 124 that provides the first-stage annular flow channel 126 (annular flow channel) between the first-stage outer cylinder 124 and the first-stage inner cylinder 123, and that includes a first-stage discharge outlet 127 (discharge outlet) opening downward at a lower end of the first-stage annular flow channel 126. The first-stage outer cylinder 124, and a second-stage outer cylinder 130 and a third-stage outer cylinder 136 that are described later are in a cylindrical shape. The first-stage outer cylinder 124 is disposed so as to face the first-stage inner cylinder 123 and the diffuser 121 described above. The first-stage annular flow channel 126 defined between the first-stage inner cylinder 123 and the first-stage outer cylinder 124 opens downward, and the first-stage discharge outlet 127 is provided downward. Therefore, the fluid 5 flowing downward through the first-stage annular flow channel 126 is discharged downward as it is through the first-stage discharge outlet 127 without changing its flow direction to a side.

The steam-water separator 1051 includes a flow-rate reducing component 141 provided in the first-stage annular flow channel 126. The flow-rate reducing component 141 (an example of a protruding portion) is provided so as to protrude to the first-stage annular flow channel 126 from at least one of surfaces of the first-stage outer cylinder 124 and the first-stage inner cylinder 123. A degree of protrusion is not particularly limited, and for example, the protrusion can be made such that a flow channel cross-sectional area of the first-stage annular flow channel 126 becomes locally 30% or more and 70% or less (for example, 50%).

The flow-rate reducing component 141 is provided to limit a flow rate of the fluid 5 (separated water) flowing into the first-stage annular flow channel 126. Although the flow-rate reducing component 141 is a ring-shaped component in the illustrated example, the component may not be independent, and may be configured by, for example, an inner surface of at least one of the first-stage inner cylinder 123 and the first-stage outer cylinder 124. That is, the protruding portion may be provided by, for example, protruding at least a part (or an entire part) in the circumferential direction on at least one of inner surfaces such that the flow channel cross-sectional area of the first-stage annular flow channel 126 is locally smaller than that of the other portion, for example. In this case, the protruding portion is a part of at least one of the first-stage inner cylinder 123 or the first-stage outer cylinder 124.

The steam-water separator 1051 includes a first-stage annular plate 128 (annular plate) that closes an upper side of the first-stage outer cylinder 124 and constitutes a circular hole whose diameter is smaller than a diameter of the first-stage inner cylinder 123. The steam-water separator 1051 includes a first-stage pick-off ring 125 (pick-off ring) that extends downward in a cylindrical shape downward from an inner peripheral edge defining the circular hole of the first-stage annular plate 128, and makes the circular hole constitute a short flow channel to the second-stage inner cylinder 129 and the second-stage outer cylinder 130 (a flow channel to an upper part of the first-stage inner cylinder 123).

The steam-water separator 1051 includes the second-stage inner cylinder 129 installed on the first-stage annular plate 128 and constituting a flow channel. The steam-water separator 1051 includes a second-stage annular flow channel 132 that concentrically surrounds the second-stage inner cylinder 129 at an interval. The steam-water separator 1051 includes the second-stage outer cylinder 130 provided with a second-stage discharge outlet 133 below the second-stage annular flow channel 132. The steam-water separator 1051 includes a second-stage annular plate 134 that closes an upper side of the second-stage outer cylinder 130 and constitutes a circular hole whose diameter is smaller than a diameter of the second-stage inner cylinder 129.

The steam-water separator 1051 includes a second-stage pick-off ring 131 that extends downward in a cylindrical shape downward from an inner peripheral edge defining the circular hole of the second-stage annular plate 134, and makes the circular hole constitute a short flow channel to the third-stage inner cylinder 135 and the third-stage outer cylinder 136. The steam-water separator 1051 includes the third-stage inner cylinder 135 installed on the second-stage annular plate 134 and constituting a flow channel. The steam-water separator 1051 includes a third-stage annular flow channel 138 that concentrically surrounds the third-stage inner cylinder 135 at an interval. The steam-water separator 1051 includes the third-stage outer cylinder 136 provided with a third-stage discharge outlet 139 below the third-stage annular flow channel 138. The steam-water separator 1051 includes a third-stage annular plate 140 that closes an upper side of the third-stage outer cylinder 136 and constitutes a circular hole whose diameter is smaller than a diameter of the third-stage inner cylinder 135.

The steam-water separator 1051 includes a third-stage pick-off ring 137 that extends downward in a cylindrical shape downward from an inner peripheral edge defining the circular hole of the third-stage annular plate 140, and makes the circular hole constitute an outlet flow channel of the steam-water separator 1051. The steam-water separator 1051 includes a hub 1222 passing through an axial center of the flow channel of the fluid 5 and a plurality of swirl vanes 1221 radially attached around the hub 1222. An inner edge of the swirl vane 1221 in the radial direction is fixed to the hub 1222. The steam-water separator 1051 includes the swirler 122 whose outer edge of the swirl vane 1221 in the radial direction is fixed to an inner wall of the diffuser 121 or the inner wall of the first-stage inner cylinder 123. The swirler 122 is disposed as an axial center in a flow channel through which the fluid 5 flows in the standpipe 120.

FIG. 20 is a horizontal sectional view illustrating a plurality of the steam-water separators 1051 of the reference example. In the reactor 142, a plurality of steam-water separators 1051 are disposed at regular intervals. A flow channel 144 through which the fluid 5 flows is provided between the plurality of steam-water separators 1051.

Next, the steam-water separator 105 of the present disclosure will be described. As described above, the steam-water separator 105 configured such that the opening 1 is further provided for the steam-water separator 1051 illustrated in FIG. 19. Therefore, the same reference numerals are given to the overlapping members, and the overlapping description will be omitted.

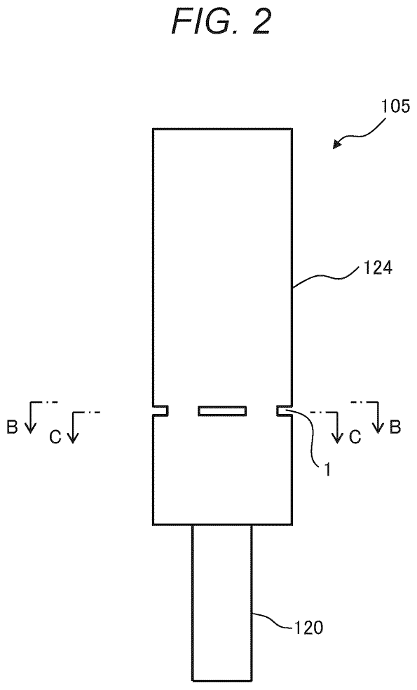

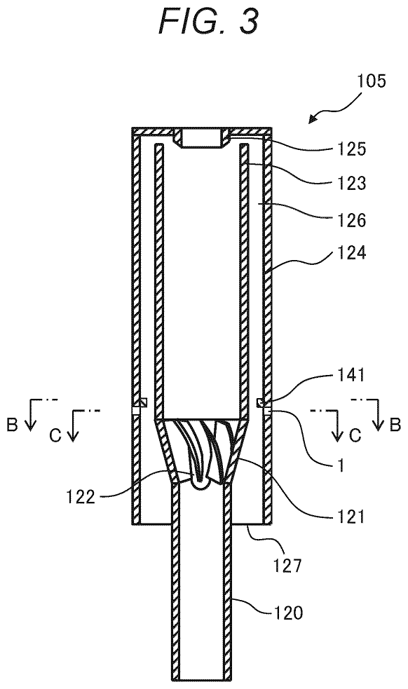

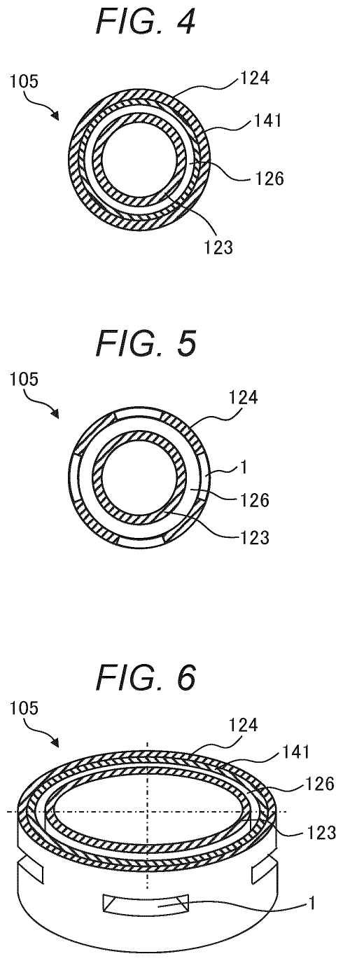

FIG. 2 is an external view of the steam-water separator 105 of the present disclosure. FIG. 3 is a longitudinal sectional view of the steam-water separator 105 illustrated in FIG. 2. In FIGS. 2 and 3, a part of the structure of the steam-water separator 105 is not illustrated. FIG. 4 is a sectional view taken along line B-B in FIGS. 2 and 3. FIG. 5 is a sectional view taken along line C-C in FIGS. 2 and 3. FIG. 6 is a bird's-eye view near the opening 1 of the steam-water separator 105 illustrated in FIG. 2 as viewed from outside of the steam-water separator 105.

The steam-water separator 105 includes the opening 1. The opening 1 is provided near a stagnation region S (described later) provided below the flow-rate reducing component 141 (protruding portion). The opening 1 discharges at least the air bubbles 6 (steam, escribed later) in the fluid 5 flowing through the steam-water separator 105 (for example, the first-stage annular flow channel 126) to outside of the first-stage outer cylinder 124. As a result, an amount of the air bubbles 6 discharged through the first-stage discharge outlet 127 which is an end point of the first-stage annular flow channel 126 can be reduced.

The fluid 5 (mainly, the water 3) discharged from the first-stage discharge outlet 127 reaches downcomer 114. Therefore, when the amount of the air bubbles 6 in the fluid 5 reaching the downcomer 114 is large, the density of the fluid 5 decreases. As a result, a difference between the density of the fluid 5 in the downcomer 114 and the density of the fluid 5 inside the core 103 becomes relatively small, and natural circulation using the density difference is less likely to occur. Therefore, by providing the opening 1, the amount of the air bubbles 6 discharged through the first-stage discharge outlet 127 can be reduced, and the density of the fluid 5 in the downcomer 114 can be relatively reduced. Thus, it possible to increase the difference between the density of the fluid 5 in the downcomer 114 and the density of the fluid 5 inside the core 103. Therefore, natural circulation using the density difference can be easily generated.

In the example of the present disclosure, the opening 1 discharges at least the air bubbles 6 existing in the stagnation region S to outside of the first-stage outer cylinder 124. However, the opening 1 may be provided in at least one of the second-stage outer cylinder 130 and the third-stage outer cylinder 136. The flow-rate reducing component 141 may also be provided for at least one of the second-stage outer cylinder 130 and the third-stage outer cylinder 136.

The opening 1 is provided in the first-stage outer cylinder 124 at least immediately below (directly below) the flow-rate reducing component 141. The opening communicates the first-stage annular flow channel 126 with outside of the first-stage outer cylinder 124, and opens toward the side of the first-stage outer cylinder 124. That is, the opening 1 communicates inside and outside of the steam-water separator 105. As illustrated in FIG. 4, in the example of the present disclosure, the flow-rate reducing component 141 has a ring shape provided over an entire region in a circumferential direction of the first-stage outer cylinder 124.

As illustrated in FIG. 5 and the like, a plurality of the openings 1 are provided at regular intervals (equal intervals) in the circumferential direction of the first-stage outer cylinder 124. Further, the flow-rate reducing component 141 is disposed on an inner surface of the first-stage outer cylinder 124 in an entire circumferential direction. Therefore, a position in the circumferential direction at which the opening 1 is provided may be any position.

The opening 1 has a shape in which a length in the circumferential direction of the first-stage outer cylinder 124 is longer than a length in the vertical direction. As used herein, the vertical direction is an extending direction of the first-stage inner cylinder 123, the first-stage outer cylinder 124, and the first-stage annular flow channel 126, and is a flow direction of the fluid 5 flowing through the first-stage annular flow channel 126. The opening 1 having such a shape allows a large number of the air bubbles 6 (described later) accumulated in the stagnation region S (described later) immediately below the flow-rate reducing component 141 to be discharged outside the steam-water separator 105.

The opening 1 has a trapezoidal shape expanding from inside to outside of the first-stage outer cylinder 124 in a top view of the first-stage outer cylinder 124. Further, the opening 1 has a rectangular shape (for example, a rectangular) in a side view of the first-stage outer cylinder 124. However, the opening 1 may have a circular shape, an elliptical shape, a rhombic shape, or the like. In the case other than the rectangular shape, the vertical length of the opening 1 is a length of a line segment connecting an uppermost end and a lowermost end of the opening 1. In this case, a length of the opening 1 in the circumferential direction of the first-stage outer cylinder 124 is a length of a portion having the longest distance in the opening 1 in the circumferential direction. Further, the number of the openings 1 may be only one, or may be more than one.

As illustrated in FIG. 3, the opening 1 is provided above an upper end of the diffuser 121. As described above, the diffuser 121 causes the flow channel cross-sectional area to be enlarged upward from an upper end of the diffuser 121. Therefore, above the diffuser 121, the cross-sectional area of first-stage annular flow channel 126 in the portion where the opening 1 is disposed is relatively small. Accordingly, it is possible to increase a change in the flow velocity by the flow-rate reducing component 141 and easily accumulate a large amount of air bubbles in the stagnation region S (described later) below the flow-rate reducing component 141. Accordingly, the air bubbles 6 (described later) can be easily discharged from the stagnation region S through the opening 1.

The opening 1 is provided at a position facing the first-stage annular flow channel 126. By providing an opening at this position, the air bubbles 6 in the fluid 5 flowing downward through the first-stage annular flow channel 126 and passing near the flow-rate reducing component 141 can be easily kept in the stagnation region S below the flow-rate reducing component 141. As a result, the water can be easily discharged outside the steam-water separator 105 through the opening 1.

The opening 1 directly faces at least one of surfaces (on a side of the first-stage outer cylinder 124) of the first-stage inner cylinder 123, the diffuser 121, or the standpipe 120. As a result, the opening 1 can be directly exposed to the first-stage annular flow channel 126, and the air bubbles 6 can be easily separated from the fluid 5 flowing through the first-stage annular flow channel 126 and retained in the stagnation region S. In the illustrated example, the opening 1 directly faces a side surface of the first-stage inner cylinder 123.

The significance of providing the opening 1 will be described below.

FIG. 7 is a view for illustrating a behavior of the fluid 5 flowing through the first-stage annular flow channel 126, and is a view illustrating a state in which a focus is given on the specific air bubbles 6 in the first-stage annular flow channel 126. The fluid 5 is contains the liquid water 3 and the air bubbles 6. Although only the local air bubbles 6 are illustrated in FIG. 7 and FIGS. 8 to 10 described later, the air bubbles 6 may actually exist in an entire or a part of the first-stage annular flow channel 126. When quality at an inlet of the steam-water separator 105 (a lower end of the standpipe 120) is high, that is, when the amount of steam is large, the air bubbles 6 (steam) flow into the first-stage annular flow channel 126 from above together with liquid water 3 (separated water) as illustrated in FIG. 7.

FIG. 8 is a view for illustrating a behavior of the fluid 5 flowing through the first-stage annular flow channel 126, and is a view illustrating a state in which the air bubbles 6 illustrated in FIG. 7 flow near the flow-rate reducing component 141. At a height position at which the flow-rate reducing component 141 is installed in the first-stage annular flow channel 126, as indicated by a thick solid arrow, a downward flow velocity becomes larger than a velocity indicated by a thin solid arrow in the other region, since the flow channel becomes narrow. Therefore, the flow velocity of the air bubbles 6 locally increases on the side of the flow-rate reducing component 141 (the portion where the flow channel cross-sectional area locally decreases).

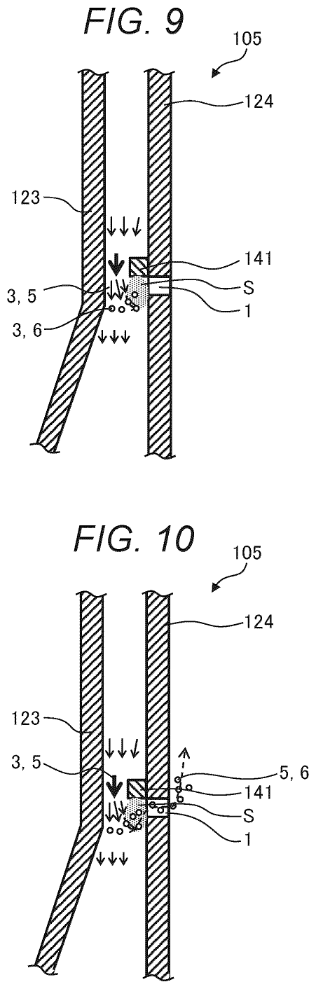

FIG. 9 is a view for illustrating a behavior of the fluid 5 flowing through the first-stage annular flow channel 126, and is a view illustrating a state when the air bubbles 6 illustrated in FIG. 7 reach obliquely below the flow-rate reducing component 141. The downward flow and the stagnation region S where the water flow stagnates due to the direct downward entrainment of the flow-rate reducing component 141 are generated from the flow of the fluid 5 passing through the side of the flow-rate reducing component 141.

Here, as the flow channel expands, the flow velocity decreases. According to the study by the present inventors, when the velocity (steam velocity) of the air bubbles 6 is calculated from the flow rate of the steam flowing into the first-stage annular flow channel 126 and a flow channel area after passing through the height position where the flow-rate reducing component 141 is installed, the velocity of the air bubbles 6 is very slow such as a velocity slower than 1 m/s, for example. Further, it was also confirmed that as a result of study of a magnitude relationship between a drag force for flowing the air bubbles 6 downward and buoyancy of the air bubbles 6, the buoyancy is larger. Therefore, due to the buoyancy generated in the air bubbles 6, the air bubbles 6 contained in fluid 5 do not easily flow directly downward, and tend to accumulate in the stagnation region S immediately below flow-rate reducing component 141.

FIG. 10 is a view for illustrating a behavior of the fluid 5 flowing through the first-stage annular flow channel 126, and is a view illustrating a state in which the air bubbles 6 existing in the stagnation region S are discharged outside the first-stage outer cylinder 124 through the opening 1. The air bubbles 6 accumulated in the stagnation region S are discharged from the opening 1 together with the liquid water 3. The discharged air bubbles 6 moves upward in the flow channel 144. This makes it possible to suppress the air bubbles 6 from flowing into the downcomer 114.

A lower surface (surface facing the opening 1) of the flow-rate reducing component 141 extends in the horizontal direction in the example of the present disclosure. However, the lower surface may have an inclination in which the height position of an end on a side close to the opening 1 becomes relatively high, for example, from the end portion on the side far from the opening 1 (left end in the illustrated example) toward an end on a side close to the opening 1 (right end in the illustrated example). Accordingly, the air bubbles 6 can easily flow into the opening 1.

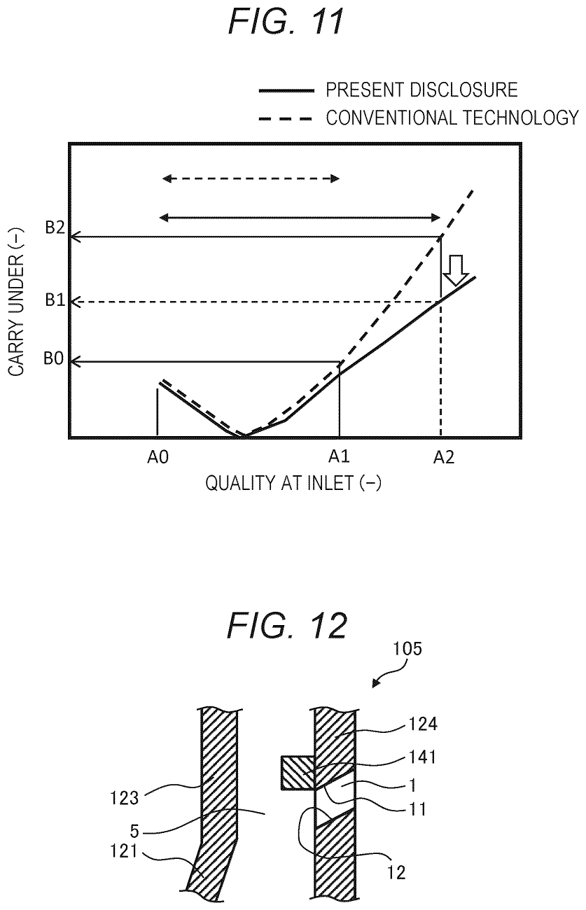

FIG. 11 is a chart showing a relationship between the quality at the inlet of the steam-water separator 105 and a carry under. A solid line is a performance curve of the steam-water separator 105 of the present disclosure, and a broken line is a performance curve of the conventional steam-water separator (PTL 1).

The horizontal axis represents the quality at the inlet of the steam-water separator 105 (the inlet of the standpipe 120), and the vertical axis represents the carry under. The quality is a ratio of a steam mass flow rate to a total mass flow rate at the inlet of the steam-water separator 105, and it can be said that the higher the quality, the larger the supply amount of steam. Therefore, the quality is preferably high. In an upper part of the graph, quality ranges targeted in the present disclosure (solid line) and the conventional technology (broken line), respective, are shown.

The carry under refers to generation of cavitation that can occur in the recirculation pump 113 (described later) or the like. In the case of the reactor 142 not including the recirculation pump 113, generation of cavitation cannot be considered. However, when the number of the air bubbles 6 is so large that cavitation occurs, a density difference in the fluid 5 between inside and outside of the core 103 becomes small, and natural convection is less likely to occur. That is, the fluid 5 hardly flows. Therefore, in order to evaluate the flow difficulty (ease of flow) of the fluid 5, the concept of carry under in which generation of cavitation is presupposed is used even in the reactor 142 not including the recirculation pump 113.

The carry under indicated by the vertical axis in FIG. 11 is a ratio of a mass flow rate at which the carry under is generated among ratios of mass flow rate rates of the air bubbles 6 in the fluid 5 discharged from the discharge flow channel of the steam-water separator 105 (first-stage discharge outlet 127). Therefore, the reactor 142 is operated at or below a ratio of the mass flow rate at which the carry under is generated.

As compared with the conventional steam-water separator (broken line), the quality range is narrower from A0 to A1, and a carry under B0 of the quality A1 has performance satisfying a conventional limit value B1. Note that the limit value B1 is an upper limit value of an operating condition that does not cause the carry under. On the other hand, with respect to the steam-water separator 105 of the present disclosure, the quality range is broadened from A0 to A2, and a carry-under at quality A2 is B1. That is, in the steam-water separator 105 of the present disclosure, since the air bubbles 6 are discharged from the opening 1, the amount of the air bubbles 6 in the fluid 5 discharged from the outlet of the steam-water separator 105 (first-stage discharge outlet 127) is reduced. Therefore, the carry under at the quality A2 can be reduced from the conventional B2 to B1.

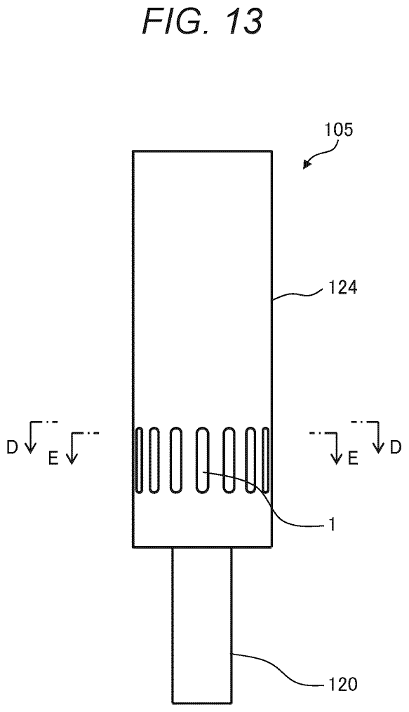

FIG. 12 is a partial sectional view of the steam-water separator 105 of another embodiment. In the steam-water separator 105 illustrated in FIG. 12, at least an upper part 11 of an inner surface constituting the opening 1 has an inclination ascending from inside to outside of the first-stage outer cylinder 124. That is, the height position of the opening of the outer surface of the first-stage outer cylinder 124 is higher than the height position of the opening of the inner surface of the first-stage outer cylinder 124. These two openings constitute the opening 1. Since the air bubbles 6 are lighter (less dense) than water, the air bubbles 6 reaching inside of the opening 1 from the stagnation region S reach a side of the upper part 11 than a side of a lower portion 12. Therefore, the air bubbles 6 can be easily discharged outside along the inclination ascending toward the outside in the opening 1.

In the example of the present disclosure, at least the lower portion 12 of the inner surface constituting the opening 1 also has an inclination ascending from inside to outside of the first-stage outer cylinder 124. Therefore, the opening 1 has a box shape having an inclination ascending from the inside to outside of the first-stage outer cylinder 124.

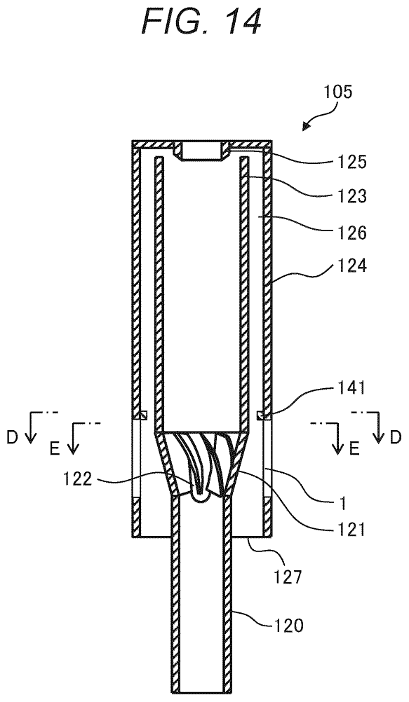

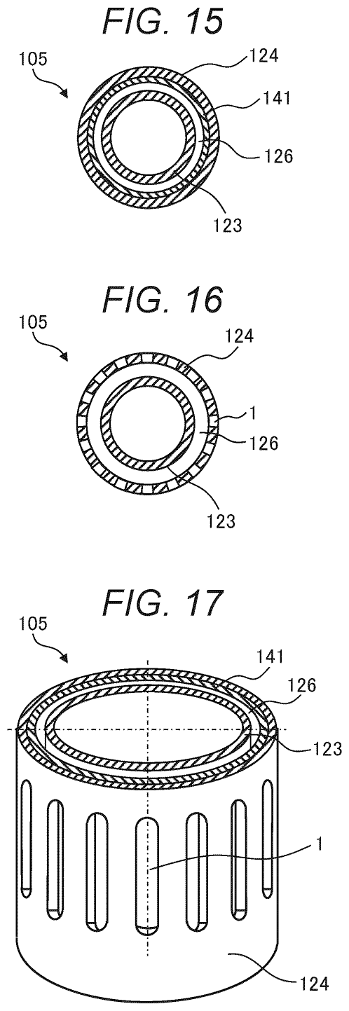

FIG. 13 is an external view of the steam-water separator 105 according to still another embodiment. FIG. 14 is a longitudinal sectional view of the steam-water separator 105 illustrated in FIG. 13. In FIGS. 13 and 14, a part of the structure of the steam-water separator 105 is not illustrated. FIG. 15 is a sectional view taken along line D-D in FIGS. 13 and 14. FIG. 16 is a sectional view taken along line E-E in FIGS. 13 and 14. FIG. 17 is a bird's-eye view near the opening 1 of the steam-water separator 105 illustrated in FIG. 13 as viewed from outside of the steam-water separator 105. The description of the opening 1 illustrated in FIGS. 2 to 6 can be similarly applied to the opening 1 illustrated in FIGS. 13 to 17, other than matters described below.

In the steam-water separator 105 shown in FIGS. 13 to 17, the opening 1 has a shape in which the length in the circumferential direction of the first-stage outer cylinder 124 is shorter than the length in the vertical direction. In this way, the air bubbles 6 flowing from the flow-rate reducing component 141 toward the first-stage discharge outlet 127 to a place away from the flow-rate reducing component 141 can be discharged through the opening 1. In particular, the length of the stagnation region S in the vertical direction becomes relatively longer when the flow velocity of the fluid 5 flowing through the first-stage annular flow channel 126 is relatively high than when the flow velocity is relatively low. Therefore, by providing the opening 1 described above, it is possible to suppress “collection failure” of the air bubbles 6.

The opening 1 has a vertically long flat shape. However, the opening 1 may have a vertically long rectangular shape. A plurality of the openings 1 are provided for the first-stage outer cylinder 124 at regular intervals in the circumferential direction. The lower end of the opening 1 in the illustrated example is at the same height as the lower end of the diffuser 121, but may be higher than the lower end of the diffuser 121 or lower than the lower end of the diffuser 121.

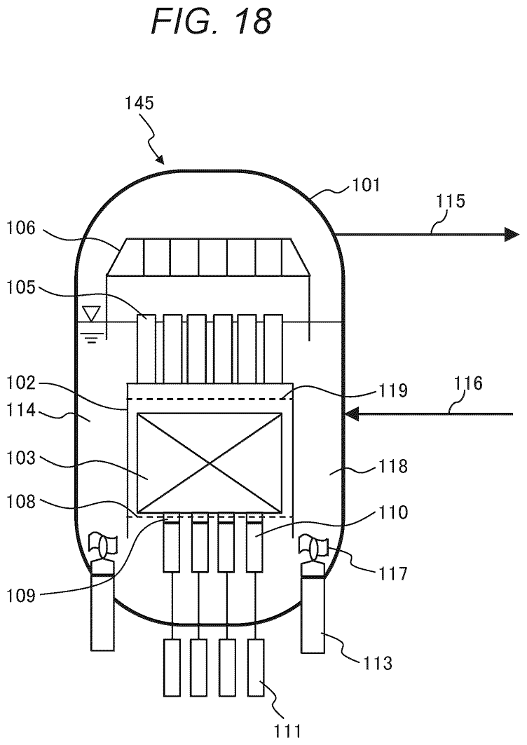

FIG. 18 is a longitudinal sectional view of a schematic structure of a boiling-water reactor (forced circulation reactor) of the present disclosure. Hereinafter, the boiling-water reactor (forced circulation reactor) of the present disclosure is referred to as a reactor 145. In the present disclosure, the natural circulation type reactor 142 is preferable, but the forced circulation type reactor 145 may be used. The reactor 145 includes the recirculation pump 113 for forcibly circulating the fluid 5 inside the reactor pressure vessel 101. On the other hand, unlike the reactor 142, the chimney 143 (FIG. 1) is not provided.

The recirculation pump 113 is an internal pump that circulates the fluid 5 inside and outside the core 103, and includes an impeller 117. By driving the impeller 117, the fluid 5 can forcibly flow through the first-stage annular flow channel 126, the second-stage annular flow channel 132, and the third-stage annular flow channel 138.

In the reactor 145, it is preferable to drive the recirculation pump 113 so as to achieve a flow rate at which the air bubbles 6 exist in the stagnation region S can be discharged through the opening 1. In particular, since the discharge of the air bubbles 6 through the opening 1 is enhanced as the flow rate is slower, it is preferable that also in the reactor 145, the recirculation pump 113 is driven so that the flow rate becomes slow. As a result, the carry under can be sufficiently avoided.

### REFERENCE SIGNS LIST

1 opening
10 stagnation region
101 reactor pressure vessel
102 core shroud
103 core
105 steam-water separator
1051 steam-water separator
106 steam dryer
108 core support plate
109 fuel support fitting
11 upper part
110 control rod guide tube
111 control rod drive mechanism
113 recirculation pump
114 downcomer
115 main steam pipe
116 feed-water pipe
117 impeller
118 coolant
119 upper grid plate
12 lower portion
120 standpipe
121 diffuser
122 swirler
swirl vane
1222 hub
123 first-stage inner cylinder (inner cylinder)
124 first-stage outer cylinder (outer cylinder)
125 first-stage pick-off ring (pick-off ring)
126 first-stage annular flow channel (annular flow channel)
127 first-stage discharge outlet (discharge outlet)
128 first-stage annular plate (annular plate)
141 flow-rate reducing component (protruding portion)
142 reactor
143 chimney
144 flow channel
145 reactor
177 impeller
3 liquid water
5 fluid
6 air bubble
9 steam-water separator
S stagnation region

1. A steam-water separator comprising:
a standpipe configured to guide a fluid containing steam and water generated in a core from a lower side to an upper side;
a diffuser connected to an upper side end of the standpipe and constitutes a flow channel, the diffuser having a flow channel cross-sectional area of the flow channel enlarged to be larger upward from the upper side end;
an inner cylinder in a cylindrical shape communicating with an upper side end of the diffuser to constitute a flow channel;
an outer cylinder in a cylindrical shape that constitutes an annular flow channel between the outer cylinder and the inner cylinder, and includes a discharge outlet at a lower end of the annular flow channel, the discharge outlet opening downward;
a protruding portion provided so as to protrude to the annular flow channel, the protruding portion protruding from at least one of surfaces of the outer cylinder and the inner cylinder;
an opening defined in the outer cylinder at least in a portion immediately below the protruding portion, the opening communicating the annular flow channel with outside of the outer cylinder and opening toward a side of the outer cylinder;
an annular plate closing an upper side of the outer cylinder and constituting a circular hole whose diameter is smaller than a diameter of the inner cylinder;
a pick-off ring extending downward in a cylindrical shape from an inner peripheral edge defining the circular hole of the annular plate, the pick-off ring making the circular hole constitute a flow channel to an upper part of the inner cylinder; and
a swirler provided as an axial center of a flow channel through which the fluid flows in the standpipe.

2. The steam-water separator according to claim 1, wherein
the opening has a shape in which a length in a circumferential direction of the outer cylinder is longer than a length in the vertical direction.

3. The steam-water separator according to claim 1, wherein
the opening has a shape in which a length in a circumferential direction of the outer cylinder is shorter than a length in the vertical direction.

4. The steam-water separator according to claim 1 wherein
at least an upper part of an inner surface constituting the opening has an inclination ascending from inside to outside of the outer cylinder.

5. The steam-water separator according to claim wherein
the outer cylinder is disposed facing the inner cylinder and the diffuser, and
the opening is provided above an upper end of the diffuser.

6. The steam-water separator according to claim 1, wherein
the opening
discharges at least the steam to outside the outer cylinder, and
is provided at a position facing the annular flow channel.

7. The steam-water separator according to claim 6, wherein
the opening directly faces at least one of surfaces of the inner cylinder, the diffuser, and the standpipe.

8. A boiling-water reactor comprising:
a reactor pressure vessel;
a core provided in the reactor pressure vessel and loaded with a fuel assembly; and
a steam-water separator provided in the reactor pressure vessel, and separates liquid water and steam from a fluid containing the steam and the liquid water generated in the core, wherein
the steam-water separator includes:
a standpipe configured to guide the fluid generated in the core from a lower side to an upper side;
a diffuser connected to an upper side end of the standpipe and constitutes a flow channel, the diffuser having a flow channel cross-sectional area of the flow channel enlarged to be larger upward from the upper side end;
an inner cylinder in a cylindrical shape communicating with an upper side end of the diffuser to constitute a flow channel;
an outer cylinder in a cylindrical shape that constitutes an annular flow channel between the outer cylinder and the inner cylinder, and includes a discharge outlet at a lower end of the annular flow channel, the discharge outlet opening downward;
a protruding portion provided so as to protrude to the annular flow channel, the protruding portion protruding from at least one of surfaces of the outer cylinder and the inner cylinder;
an opening defined in the outer cylinder at least in a portion immediately below the protruding portion, the opening communicating the annular flow channel with outside of the outer cylinder and opening toward a side of the outer cylinder;
an annular plate closing an upper side of the outer cylinder and constituting a circular hole whose diameter is smaller than a diameter of the inner cylinder;
a pick-off ring extending downward in a cylindrical shape from an inner peripheral edge defining the circular hole of the annular plate, the pick-off ring making the circular hole constitute a flow channel to an upper part of the inner cylinder; and
a swirler provided as an axial center of a flow channel through which the fluid flows in the standpipe.

9. The boiling-water reactor according to claim 8, comprising
a natural circulation type boiling-water reactor.
